(19) United States
(12) Patent Application Publication
(10) Pub. No.: US 2012/0199216 A1
(43) Pub. Date: Aug. 9, 2012

(54) Drain Cover Adjuster

(76) Inventor: Herbert John Schramer, Geneva, IL (US)

(21) Appl. No.: 13/366,072

(22) Filed: Feb. 3, 2012

Related U.S. Application Data
(60) Provisional application No. 61/439,559, filed on Feb. 4, 2011.

(51) Int. Cl. F16L 5/00

(52) U.S. Cl. 137/362

(57) ABSTRACT

A drain or ducting adjustment system may include a plurality of shims to elevate or space a cover from a flange or base portion of the drain or ducting. Each shim may have a recess proximate its top end to receive the cover or a higher shim and engagement means such as a lip or threading to receive the base portion or a lower shim. Shims may be of various heights. Additionally, one or more shims may allow for an angled offset between the recess and lip, in the event that the base portion of the drain or ducting is not parallel to the ultimate substrate height. Preferably, the base of the recess and lip are generally parallel to their respective end surfaces and the recess and lip are generally cylindrical such that adjacent shims may be rotationally adjusted relative to one another to achieve a desired offset angle.

This application claims the benefit of priority from U.S. Provisional Application 61/439,559, filed Feb. 4, 2011.

### BACKGROUND OF THE INVENTION

1. Field of the Invention

The present invention relates to adjusting the level, pitch or other positioning of the grate, strainer or other cover of a drain or ducting system relative to the open end of the drain or duct and to the surface of any medium that surrounds the open end of the drain or duct.

2. Description of the Related Art

A floor drain system is used to channel liquids and other matter from the floor of an area or room to another location. FIGS. 1 and 1A show a typical drain floor drain system, which may include a drain body (such as a drain pipe) 1 to which a flange or like fixture 2 may be affixed at the open end 3 of the floor drain system. Typically, flange 2 includes male threads for threadingly engaging drain body 1 and for adjusting height of flange 2. As shown in FIG. 1, the open end of the floor drain system leads to or passes through an opening 34 in a floor. A “cover” is a grating, strainer or other type of cover intended to be placed at the open end of the floor drain system. A cover such as a grate 4 often is affixed to the open end 3 of the floor drain system, where the “open end” of the floor drain system is the end of the floor drain system into which liquids or other matter to be channeled first enter. Cover 4 may reside within a lip of flange 2, as seen in FIG. 1. Additionally, as seen in FIG. 1A, one or more fasteners may pass through fastener openings in cover 4 to engage with flange 2.

A recurrent problem during the construction of a floor drain system is adjusting the level of the open end 3 of the floor drain system to achieve a desired position of the cover 4 relative to the level of the surrounding floor 5 or floor covering 6. Typically, a floor drain system is installed before installation of the surrounding floor 5 or floor covering 6. For example, the drain body may be installed and a concrete foundation poured around it. Prior to pouring the foundation, the height of flange 2 may be adjusted to a desired height, but the contractor may not know the level at which the open end 3 of the floor drain system should terminate in order to achieve a desired positioning of the cover 4 relative to the level of the final floor covering 6. The contractor then may pour the foundation until it is level with the open end 3. After the foundation is poured, the concrete may set, adhering itself to the flange 2, including filling the exposed screw threads of flange 2 above drain body 1, thereby preventing rotation and/or translation of the flange 2 to adjust its height. If future adjustment is desired, the portion of the concrete floor around the floor drain must be chiseled away, the level of the open end of the floor drain system adjusted, and the concrete flooring re-poured. Such repairs, adjustments, removals and replacements involve substantial added time and expense.

Moreover, adjustment of the flange may require unthreading it relative to drain body 1. Depending on the height misalignment with floor 5 or floor covering 6, flange 2 may be unthreaded to a point where only a minimal pitch of the threading between flange 2 and drain body 1 remain engaged. It also is possible that flange 2 may require so much unthreading that it becomes uncoupled from drain body 1.

In addition, the open end 3 of the floor drain system often is exposed to damaging or unsanitary construction traffic throughout the pendency of construction. Among other resulting problems, this may require that the open end 3 of the floor drain be repaired or replaced, or the level of the open end must be adjusted. In order to repair or replace the damaged or dirtied portion of the floor drain system, or adjust the level of the open end 3 of the floor drain system, often the portion of the floor 5 or floor covering 6 surrounding the perimeter of the floor drain system must be removed and replaced.

For the foregoing reasons, there is a need for a device that can easily and variably adjust the level, pitch or other positioning of the cover 4 of a floor drain or other type of piping or ducting system relative to the open end 3 of the system and to the surface of any floor 5 or other type of substrate or of covering 6 that surrounds the open end 3 of the floor drain system, without the need for time consuming or expensive repairs, adjustments, removals or replacements of floor, floor covering or floor drain system materials.

### BRIEF SUMMARY OF THE INVENTION

In one embodiment, a drain adjustment system may include a shim configured to be disposed between a drain flange and a drain cover, the shim including: a top side and a bottom side with an external side wall and an internal bore therebetween, a recess extending downward from the top side, internally around a perimeter, and a lip extending upward from the bottom side, externally around the perimeter. The recess may have a base that substantially lies in a first plane, the lip may have a base that substantially lies in a second plane, and the first and second planes may be offset from one another. The recess and lip also may extend generally perpendicularly downward from the top side or upward from the bottom side, respectively.

In addition, the shim may include a tongue extending outward from and around a sidewall of the lip in a third plane, the third plane substantially parallel to the second plane. Similarly, the shim may include a groove extending inward from and around a sidewall of the recess in a fourth plane, the fourth plane substantially parallel to the first plane.

The external sidewall may include a first portion proximate the top side and substantially perpendicular to the top side and a second portion proximate the base of the lip and substantially perpendicular to the lip base. Similarly, the internal bore may include a first portion proximate the base of the recess and substantially perpendicular to the recess base and a second portion proximate the bottom side and substantially perpendicular to the bottom side.

The drain adjustment system also may include second shim having a top side and a bottom side, a recess extending downward from the top side, internally around a perimeter, and a lip extending upward from the bottom side, externally around the perimeter. The second shim recess may be capable of operatively engaging the first shim lip, and the second shim lip may be capable of operatively engaging the first shim recess. When the first and second shims are operatively engaged, at least one of the first and second shims may be capable of rotating relative to the other of the first and second shims. In addition, the first shim may have a first height between an uppermost part of the top side and the lowermost part of the bottom side, and the second shim may have a second height between an uppermost part of the top side and the lowermost part of the bottom side, where the first height is different than the second height and/or the top side of the first shim angles a different degree with respect to the bottom side of the first shim than the top side of the second shim angles with respect to the bottom side of the second shim.

In another embodiment, a drain adjustment system may include at least one shim configured to be disposed between a drain flange and a drain cover, the shim having: a top side having a recess extending internally around a perimeter of the top side, the recess configured to receive the drain cover and a bottom side having means for operatively engaging the drain flange. The means for operatively engaging the drain flange may include a lip extending externally around a perimeter of the bottom side, threading to couple with drain threading, or other connection means.

The system also may include a second shim. The first and second shims may have different heights. There also may be a gasket configured to be disposed between the first and second shims. In addition, the recess in the top side of the first shim may be configured to receive the second shim, the second shim including a top side having a recess configured to receive the drain cover and a bottom side having a lip configured to be received by recess in the top side of the first shim.

In still another embodiment, a pipe or ducting adjustment system may include a plurality of shims, each shim having a top end and a bottom end with a height measured between an uppermost part of the top end and a lowermost part of the bottom end, a recess extending downward from the top end, the recess having a base lying in a plane generally parallel to the top end, and a lip extending upward from the bottom end, the lip having a base lying in a plane generally parallel to the bottom end. Each recess may be configured to receive a cover and further wherein each lip is configured to be received in a recess of a pipe or duct. The height of a first shim may be different than the height of a second shim and/or a degree of offset between the recess base plane and lip base plane of the first shim may be different than the degree of offset between the recess base plane and lip base plane of the second shim. Shims may have various shapes such as cylindrical or cubed (with internal bores) and/or cross-sections such as rectangular, square, circular, etc.

These and other features and advantages are evident from the following description of the present invention, with reference to the accompanying drawings.

### BRIEF DESCRIPTION OF THE SEVERAL VIEWS OF THE DRAWINGS

FIG. 1 is a sectional view of a typical installation of a floor drain system.

FIG. 1A is a top view of the drain system of FIG. 1.

FIG. 2 is an exploded elevational view of one embodiment of a floor drain cover adjuster including a plurality of spacing shims or adjuster rings.

FIG. 3 is a sectional view of the shims of FIG. 2.

FIG. 4 is a top view of a one of the shims of FIG. 2.

FIG. 5 is a bottom view of a one of the shims of FIG. 2.

FIG. 6 is an exploded elevational view of a floor drain system with a protective cap.

FIG. 7 is a sectional view of a second embodiment of a spacing shim, the shim having a pitch when viewed from side to side across the cross-section.

FIG. 8 is a partial sectional view of a plurality of joined shims made according to the second embodiment.

FIG. 9 is a sectional view of a plurality of joined shims made according to the second embodiment.

FIG. 10 is a side view of another embodiment of a shim.

FIG. 11 is a side view of a plurality of shims of FIG. 10 operatively engaged with one another, with a gasket therebetween.

FIG. 12 is a section view of the shim of FIG. 10 with its bottom end generally level and its top end skewed.

FIG. 13 is a section view of the shim of FIG. 10 with its bottom end skewed and its top end generally level.

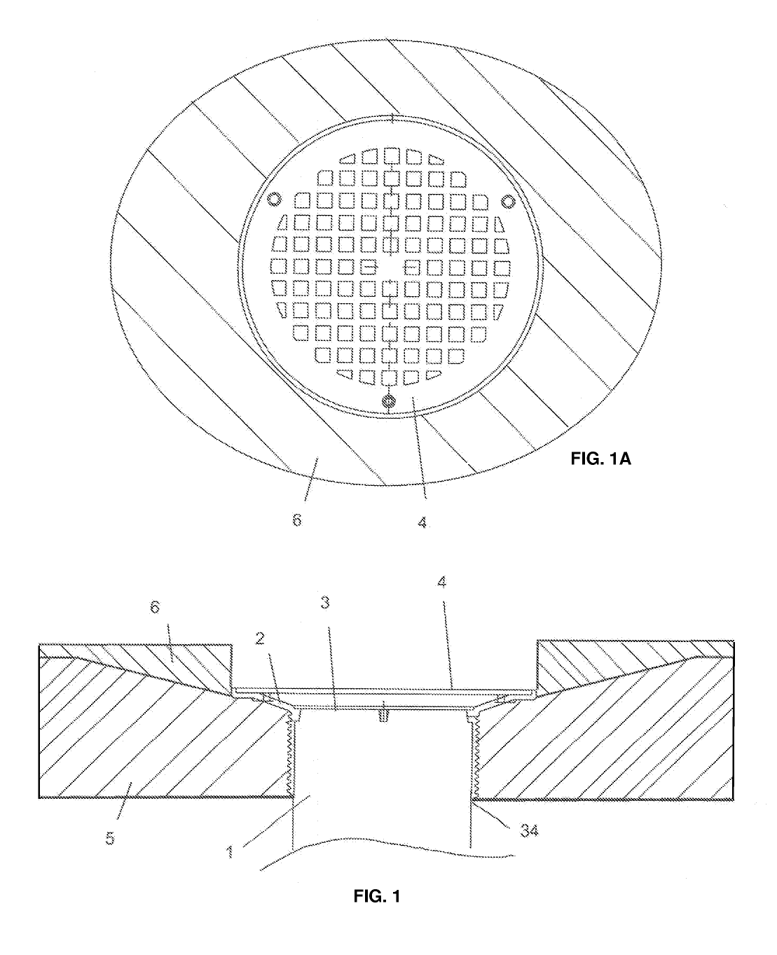

### DETAILED DESCRIPTION OF THE INVENTION

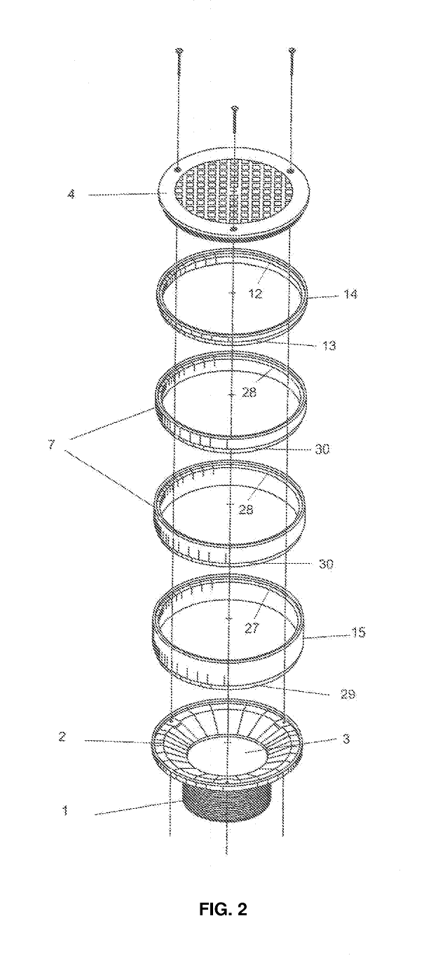

As shown in FIG. 2, in one embodiment, a cover adjuster may include a plurality of rings or shims including a top ring 14 and a bottom ring 15 that are inserted in between the cover 4 and the open end 3 of the floor drain system, and may include one or more interior rings 7 that are inserted in between the top ring 14 and the bottom ring 15. Although a plurality of rings are shown in FIG. 2, the adjuster may include only a single ring, which may be selected so as to raise cover 4 to the desired height.

Turning to FIG. 3, the top ring 14, the bottom ring 15 and the interior ring 7 each have an axial length 8 and an exterior radial length 9. As seen in FIG. 3, the axial length of each ring may differ from that of the other rings and may be denoted by dimension “a.”

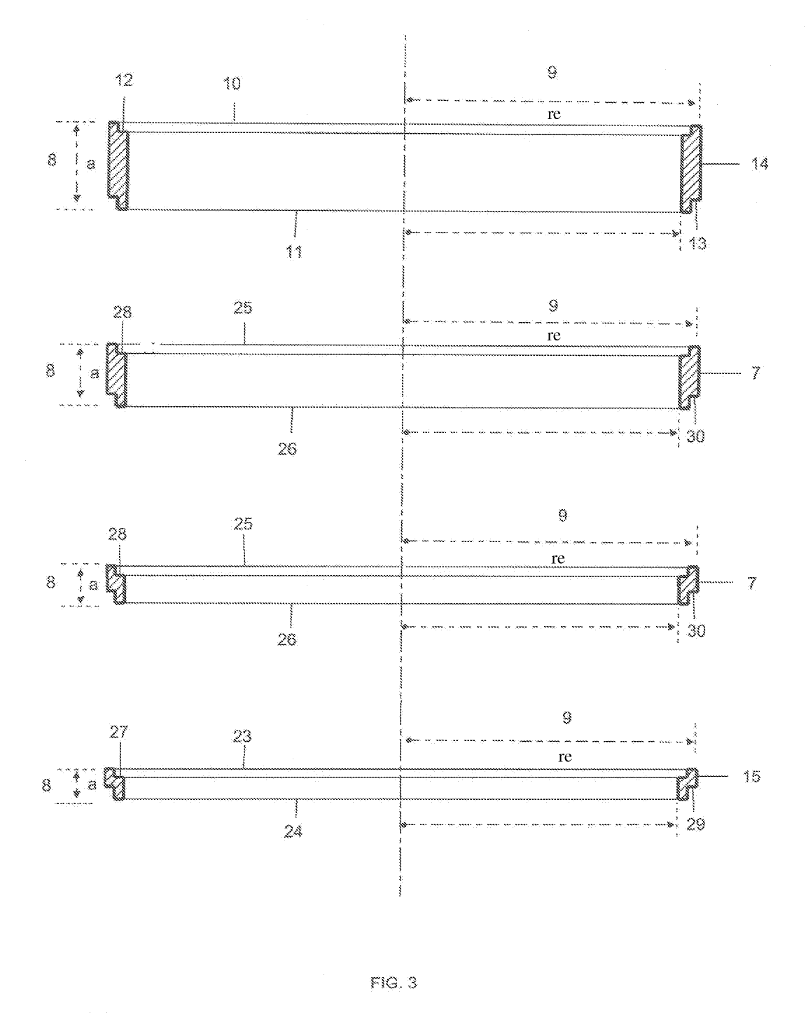

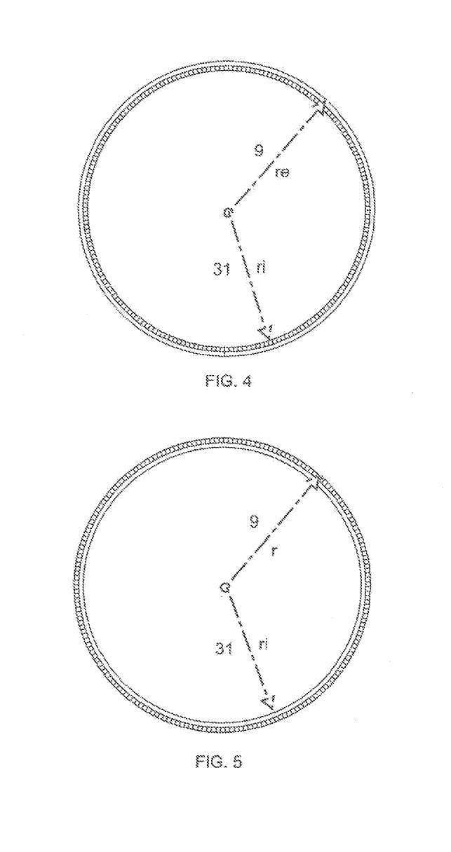

FIG. 4 shows a top plan view of a floor drain cover adjuster top ring 14, bottom ring 15 or interior ring 7. FIG. 5 shows a bottom plan view of a floor drain cover adjuster top ring 14, bottom ring 15 or interior ring 7. As these figures may illustrate any of the rings, it will be appreciated that the exterior radial length for each ring may be substantially equal and may be denoted by dimension “re,” and the interior radial length 31 also may be substantially equal and may be denoted by the dimension “ri.” Conversely, one or both of the exterior radial length “re” of a ring and the interior radial length “ri” of a ring may be varied, provided that a radial length to annular recess 13 is substantially the same as a radial length to annular radius 28 and a length to annular recess 30 is substantially the same as a radial length to annular recess 29.

The top ring 14 has an axial top end 10 and an axial bottom end 11. The bottom ring 15 has an axial top end 23 and an axial bottom end 24. Each interior ring 7 has an axial top end 25 and an axial bottom end 26. The axial top end 10 of the top ring 14 has a notch running the length of the circumference of the inside of the top ring 14 that forms an annular recess 12 in the interior of the top end 10 of the top ring 14. The axial top end 23 of the bottom ring 15 has a notch running the length of the circumference of the inside of the bottom ring 15 that forms an annular recess 27 in the interior of the top end 23 of the bottom ring 15. The axial top end 25 of the interior ring 7 has a notch running the length of the circumference of the inside of the interior ring 7 that forms an annular recess 28 in the interior of the top end 25 of the interior ring 7.

The axial bottom end 11 of the top ring 14 has a notch running the length of the circumference of the outside of the top ring 14 that forms an annular recess 13 on the exterior of the bottom end 11 of the top ring 14. The axial bottom end 24 of the bottom ring 15 a notch running the length of the circumference of the outside of each ring that forms an annular recess 29 on the exterior of the bottom end 24 of the bottom ring 15. The axial bottom end 26 of each interior ring 7 each has a notch running the length of the circumference of the outside of the interior ring 7 that forms an annular recess 30 on the exterior of the bottom end 26 of the interior ring 7.

Returning to FIG. 2, the annular recess 29 on the exterior of the bottom end 11 of the bottom ring 15 to be affixed to the floor drain system fits within the interior of the open end 3 of the floor drain system. The annular recess 30 on the exterior of the bottom end 26 of the interior ring 7, if any, to be affixed to bottom ring 15 fits within the interior of the annular recess 27 of the top end of the bottom ring 15. The annular recess 13 on the exterior of the bottom end 11 of the top ring 14 fits within the interior of the annular recess 28 of the top end of the interior ring 7. If no interior ring 7 is used, the annular recess 13 on the exterior of the bottom end 11 of the top ring 14 fits within the interior of the annular recess 27 of the top end of the bottom ring 15.

The cover 4 is affixed to the axial top end 10 of the top ring 14 and secured with screws or other fasteners to the drain system. Cover 4 may be a grate-type cover with openings into drain body 1. Alternatively, drain body 1 may be for clean-out, such that cover may be solid, with no openings other than fastener openings.

If no top ring 14 or interior rings 7 are used, the cover may be disposed within the annular recess 27 on the top end of the bottom ring 15. Fasteners may bypass and be disposed radially closer than interior radial length “ri.” As such, compression of cover 4 by fasteners, coupled with operative engagement of annular recesses of adjacent rings with each other and of recesses with cover 4 and flange 2 may retain rings securely in position. The user may select fasteners from among various lengths to use fasteners size appropriately for the number and height of rings used, e.g., more rings may require the use of longer fasteners to span the gap between cover 4 and flange 2. Alternatively, the cover system may include break-off or multi-section-type fasteners that may include unthreaded shank portions between thread sections. A user may cut, snip, or otherwise sever the fastener shank at one of these unthreaded shank portions to shorten the fastener to the desired length.

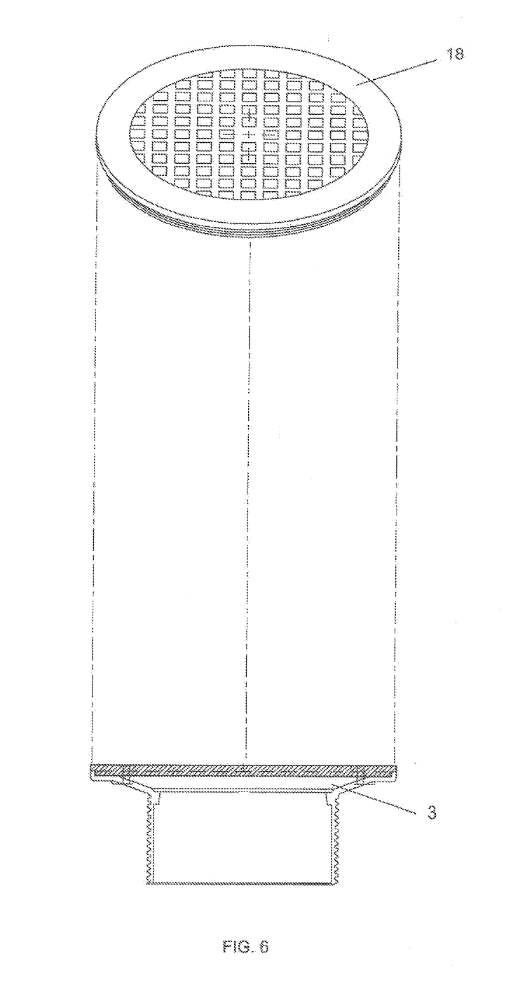

Turning to FIG. 6, the cover system also may include a protective cap 18 that may be placed over the open end 3 of the floor drain system prior to commencement of construction activities that could otherwise dirty or damage the open end 3 of the floor drain system. Upon completion of construction, cap 18 may be removed and replaced with cover 4.

In some cases, floor 5 or floor covering 6 surrounding flange 2 may not be level. In other cases, floor 5 or floor covering 6 may be substantially level, while drain body 1 and/or flange 2 may not be installed substantially perpendicular to floor 5 and/or floor covering 6.

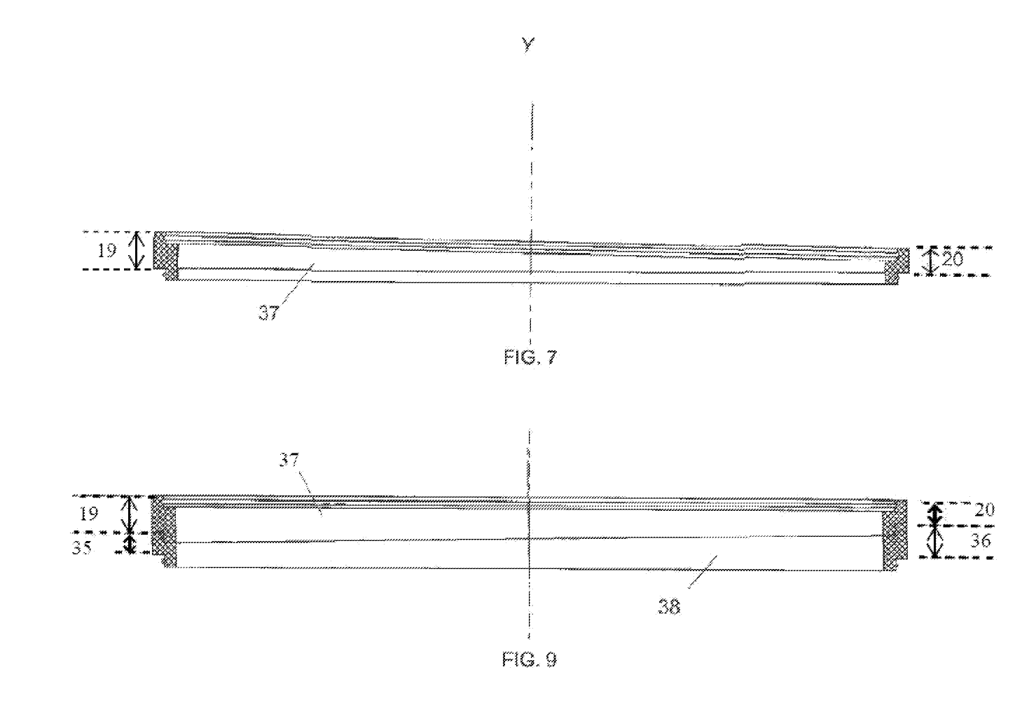

Turning now to FIG. 7, in another embodiment, the axial length on one side 19 of a cross-section of ring 37 may be made longer than the axial length of the opposite side 20 of the cross-section of ring 37. This can be done to adjust the pitch of the top ring 14 within which the cover 4 fits so that the pitch of the cover 4 adjusts to correspond with a particular pitch of the floor 5 or floor covering 6. The ring 37 may be rotated along the y axis to adjust the pitch of the cover 4 in different directions. As shown in FIG. 9, a second ring 38 with an axial length on one cross-section side 36 longer than the axial length of the opposite cross-section side 35 of the ring 38 may be affixed to the first ring 37 with an axial length on one cross-section side 19 longer than the axial length of the opposite cross-section side 20 of the ring 37 where the second ring 38 and the first ring 37 each may be rotated along the y axis to different degrees to adjust the pitch of the cover 4 in more than one direction. Rotating top ring 37 may reduce the degree to which cover 4 may be pitched as longer cross-section side 19 becomes more aligned with shorter cross-section side 35, as seen in FIG. 9. Alternatively, pitch of cover may be exaggerated as top ring 37 is rotated so that longer cross-section sides 19, 36 become more closely aligned.

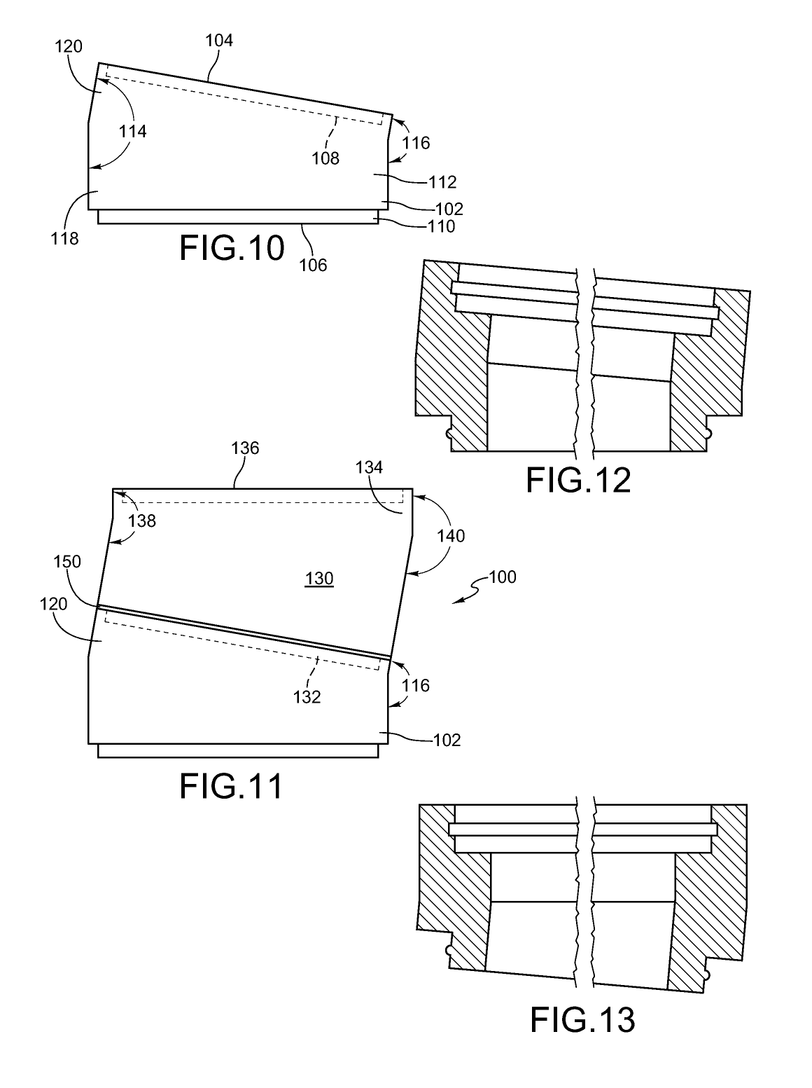

Turning now to FIGS. 10-13, an additional embodiment of pitch adjusting shim system 100 is shown. In FIG. 10, shim 102 again includes a top end 104, a bottom end 106, an annular recess 108 in top end 104, an annular recess 110 in bottom end 106, and a surrounding sidewall 112. Instead of extending in a single, generally axial direction, sidewall 112 may include one or more angular bends, 114, 116, dividing sidewall 112 into a generally axial portion 118 and an angled portion 120. Angular bends 114, 116 may be angled at substantially the same angle, such that generally axial portion 118 may have substantially the same cross-sectional shape, albeit offset, as the cross-sectional shape of angled portion 120.

Additionally, a similar angled offset means that recess 108 in top may have substantially the same shape as if shim 102 did not include an offset. For example, if shim 102 is cylindrical, recess 108 also may be cylindrical, allowing for easy rotation of a second shim 130 to achieve desired offset angle.

Forming offset in the manner described above and shown in FIG. 7 may allow for adjustment to match unlevel flange 2, floor 5, or floor covering 6, but it may result in recess 108 having a different shape than a bottom recess/flange 132, which may make rotational adjustment more difficult. For example, if shim 102 is cylindrical, cutting across top end 104 would give recess 108 an elliptical shape, which may result in interference as flange 132 is rotated within recess 108.

Shim 102 may be employed if flange 2 is level and floor 5 and/or floor covering 6 is not, such that sidewall portion 118 may extend generally vertically and sidewall portion 120 may angle to match floor 5 and/or floor covering 6. Alternatively, shim 102 may be employed if flange 2 is angled and floor 5 and/or floor covering 6 is level. In that case, sidewall portion 118 may be angled substantially similarly to flange 2 and sidewall portion 120 may extend generally vertically.

Turning to FIG. 11, a plurality of angled shims 102, 130 may be operatively coupled to one another. Shims may include angled portions that angle at similar or different angles from one another and may rotate relative to one another to match the angle offset between flange 2 and floor covering 6. For example, if shim 102 includes a 1° angle and shim 130 also includes a 1° angle, shims may be relatively aligned to result in a net 0° offset, as seen in FIG. 11. To achieve this effect, the longest portion of angled sidewall portion 120 of shim 102 may be diametrically offset from the longest angled sidewall portion 134 of shim 130. Alternatively, if the longest portions of angled sidewall portions 120, 134 are aligned, the 1° offsets may aggregate to result in a net 2° offset of shim system 100. If flange 2 and floor covering 6 are offset by some amount between the minimum and maximum possible offset amounts, shim 130 may be rotated such that the longest portion of sidewall 134 is somewhere between aligned with and diametrically offset from longest portion of sidewall 120, until alignment of the top 136 of shim 130 with floor covering 6 is obtained.

It may be desirable to minimize the amount of lateral displacement of shim system 100 relative to flange 2, so that cover 4 may overlay open end 3 of flange 2 as much as possible. For example, even if flange 2 is level but floor covering 6 is not, the opening formed by floor covering 6 generally may directly overlay open end 3. If flange 2 (or an immediately lower shim) is generally level, it may be preferable for angled sidewall portion 120 of shim 102 (angled relative to flange) to account for a small percentage of the shim's overall length. As seen in FIG. 11, this may be achieved by locating a lowermost portion of top end 104 proximate angled bend 116. If flange 2 (or an immediately lower shim) is offset while floor covering is generally level, it may be preferable to locate a lowermost portion of bottom end 106 proximate angled bend 116, i.e., maximizing portion of sidewall 112 that is angled relative to flange 2 but which extends generally perpendicular to opening in floor covering 6. By minimizing lateral displacement, it may be possible to maximize alignment between fastener openings in cover 4 and in flange 2.

Alternatively, floor 5 may overlay opening while floor covering 6 is installed so as to create an offset between an opening in floor covering 6 and open end 3. In that case, the points along a height of shim where angling begins may be adjusted to achieve the desired degree of offset. For example, if flange 2 (or an immediately lower shim) is generally level, placing angular bends 114, 116 closer to bottom end may increase the amount of offset. If flange 2 (or an immediately lower shim) is angled, lateral offset may be increased by locating angular bends 138, 140 closer to top 136 as seen with the upper shim 130 in FIG. 11.

FIG. 11 also illustrates a gasket 150 disposed between shims 102, 130. Gasket preferably may be a thin, waterproof, and/or solvent resistant material such as rubber or a rubber-type material. Preferably, gasket 150 has a height less than a height of annular recess 108 and of flange 132 so that flange 132 remains seated within recess 108 when shims 102, 130 are operatively coupled.

It may be possible for a lower portion of sidewall to be generally perpendicular to the flange or immediately lower shim, as seen in FIG. 12, with the upper portion of the sidewall relatively angled. Alternatively, the lower portion may be angled, with the upper portion generally perpendicular as seen in FIG. 13. This may be a frame of reference question, as the lower portion remains generally perpendicular to the lower annular recess in both instances.

In still another embodiment, lower portion may be angled relative to the lower annular recess. In this case, to achieve the desired offset angle while maintaining the desired shape of annular recess in the top, the shim may require a second offset so as to avoid the elliptical offset case discussed above. The degree of the second offset preferably determines the degree to which the top annular recess is angled, as the recess preferably is generally perpendicular to that second offset. Thus, the steeper the second offset, the more the annular recess is inclined.

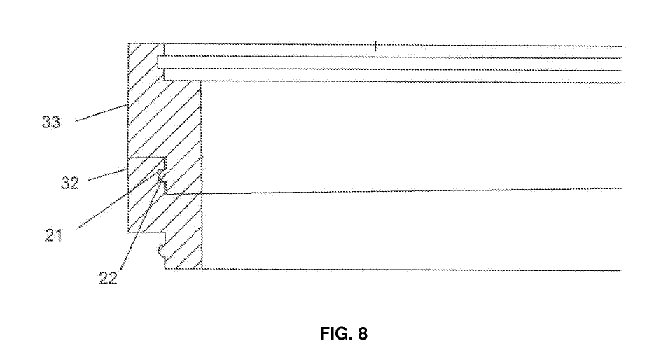

As shown in FIG. 8, in any embodiment, a groove 21 may be inserted in the vertical portion of the notch running the length of the circumference of the inside of a first ring 32 and a corresponding tongue 22 may be inserted on the vertical portion of the notch running the length of the circumference of the outside of a second ring 33. Groove 21 may be in lower ring 32 and tongue 22 in upper ring 33, although the reverse also is possible. When tongue 22 running the length of the circumference of the outside of the second ring 33 is inserted into the notch running the length of the circumference of the inside of the first ring 32, the tongue 22 will fit into the groove 21 in order to make a tighter seal. Additionally, tongue and groove arrangement may assist in keeping rings engaged as upper ring is rotated to adjust the pitch to match floor 5 or floor covering 6.

The shape of the present invention is not limited to a ring, but may be varied to correspond to any shape of a floor drain system such as a square or other shape. In any event, rings alternatively may be referred to as shims. In the case of rectangular shims, angular offsets may be achieved by offsetting one side at a different height than its opposite side with the two adjacent sides angled between the two opposing sides. Alternatively, the offset may occur at a corner between sides, where the other three corners are at a similar height and the fourth corner is offset.

Additionally, the references herein to circumferential and radial lengths, dimensions, sides, etc., may be interpreted to apply to the respective internal or external perimeters and distances from a center of the shim to the internal or external sides of the shim. Moreover, the system may be used for more than just drain applications and also may apply to any application having piping, tubing, ducting, etc., with a cover and a surrounding substrate. For example, it may be used with HVAC-type ducting in a floor or wall.

In operation, as shown in FIG. 6, after a floor drain system is installed, cover 4 or protective cover 18 may be placed over the floor drain system, without any shims between flange 2 and either cover. After the desired amount of construction activity is completed, the cover may be removed, exposing a clean and undamaged open end 3 of the floor drain system. Thereafter, as shown in FIG. 2, in order to vary and adjust the level of the cover relative to the open end of the floor drain system and to the surface of any medium that surrounds the open end of the floor drain system, one or more rings, e.g., a top ring 14, a bottom ring 15, and zero or more interior rings 7, are inserted in between the cover 4 and the open end 3 of the floor drain system. To adjust the pitch, a ring of the type shown in FIG. 7, with a variable axial length may be used in addition to or in substitution of one or more of the aforementioned rings. The cover is then placed on the top ring, and screws or other fasteners are used to secure the cover in place. If a tighter seal between the rings is required, then rings with a tongue and grove shape as shown in FIG. 8 may be used.

In still another embodiment, shim system may take advantage of flange threading to couple rings to flange 2 and/or to adjust cover height. For example, when flange 2 is created, external threading is formed in a shaft portion to couple flange 2 to drain body 1. This process may create similar threading on an internal portion of flange 2. Instead of operatively engaging lip of flange 2, annular recess 29 on a bottom ring may include mating threading to engage this internal threading. The interior radial length “ri” of this ring at the bottom may be shrunken to be more closely sized to match diameter of drain body 1 instead of generally matching diameter of flange 2 at open end 3. The ring then may expand radially along at least a portion of its axial length “a” to match diameter of cover 4 or of lower end of an adjacent ring. This additional type of operative engagement means may securely couple the ring to flange 2. It also may allow for adjustment of the ring height by rotating the ring relative to flange 2.

Shims may be made of materials that may match code requirements for drain parts or of materials that are resistant to whatever may be sent down the drain. For example, shims may be made of a brass-nickel alloy, schedule 80 PVC or some other material, as would be appreciated by one in the art.

This shim system overcomes the deficiency of the prior art where repairs, adjustments, removals or replacements of floor, floor covering or floor drain materials were required in order to achieved the desired positioning of the cover relative to the level of the surface of the floor or floor covering.

While the foregoing written description enables one of ordinary skill to make and use what is considered presently to be the best mode thereof, those of ordinary skill will understand and appreciate the existence of variations, combinations, and equivalents of the specific exemplary embodiments and methods herein. The invention should therefore not be limited by the above described embodiments and methods, but by all embodiments and methods within the scope and spirit of the invention as claimed.

What is claimed is:

1. A drain adjustment system, comprising:
a shim configured to be disposed between a drain flange and a drain cover, the shim including:
a top side and a bottom side with an external side wall and an internal bore therebetween;
a recess extending downward from the top side, internally around a perimeter; and
a lip extending upward from the bottom side, externally around the perimeter;
wherein the recess has a base that substantially lies in a first plane;
wherein the lip has a base that substantially lies in a second plane; and
wherein the first and second planes are offset from one another.

2. A drain adjustment system according to claim 1, wherein the recess extends generally perpendicularly downward from the top side.

3. A drain adjustment system according to claim 1, wherein the lip extends generally perpendicularly upward from the bottom side.

4. A drain adjustment system according to claim 1, further comprising a tongue extending outward from and around a sidewall of the lip in a third plane, the third plane substantially parallel to the second plane.

5. A drain adjustment system according to claim 4, further comprising a groove extending inward from and around a sidewall of the recess in a fourth plane, the fourth plane substantially parallel to the first plane.

6. A drain adjustment system according to claim 1, wherein the external sidewall includes:
a first portion proximate the top side and substantially perpendicular to the top side; and
a second portion proximate the base of the lip and substantially perpendicular to the lip base.

7. A drain adjustment system according to claim 1, wherein the internal bore includes:
a first portion proximate the base of the recess and substantially perpendicular to the recess base; and
a second portion proximate the bottom side and substantially perpendicular to the bottom side.

8. A drain adjustment system according to claim 1, further comprising a second shim having:
a top side and a bottom side;
a recess extending downward from the top side, internally around a perimeter; and
a lip extending upward from the bottom side, externally around the perimeter;
wherein the second shim recess is capable of operatively engaging the first shim lip and the second shim lip is capable of operatively engaging the first shim recess.

9. A drain adjustment system according to claim 8, wherein, when the first and second shims are operatively engaged, at least one of the first and second shims is capable of rotating relative to the other of the first and second shims.

10. A drain adjustment system according to claim 8, the first shim having a first height between an uppermost part of the top side and the lowermost part of the bottom side;
the second shim having a second height between an uppermost part of the top side and the lowermost part of the bottom side, wherein at least one of the following is true:
the first height is different than the second height; and
the top side of the first shim angles a different degree with respect to the bottom side of the first shim than the top side of the second shim angles with respect to the bottom side of the second shim.

11. A drain adjustment system, comprising:
at least one shim configured to be disposed between a drain flange and a drain cover, the shim including:
a top side having a recess extending internally around a perimeter of the top side, the recess configured to receive the drain cover; and
a bottom side having means for operatively engaging the drain flange.

12. A drain adjustment system according to claim 1,
wherein the means for operatively engaging the drain flange includes a lip extending externally around a perimeter of the bottom side.

13. A drain adjustment system according to claim 1, further comprising a second shim, wherein:
the shim has a height and the second shim has a second, different height.

14. A drain adjustment system according to claim 1, further comprising a second shim and a gasket configured to be disposed between the first and second shims.

15. A drain adjustment system according to claim 1, wherein the recess in the top side additionally is configured to receive a second shim, the second shim including a top side having a recess configured to receive the drain cover and a bottom side having a lip configured to be received by recess in the top side of the first shim.

16. A pipe or ducting adjustment system, comprising a plurality of shims, each shim having:
a top end and a bottom end with a height measured between an uppermost part of the top end and a lowermost part of the bottom end;
a recess extending downward from the top end, the recess having a base lying in a plane generally parallel to the top end; and
a lip extending upward from the bottom end, the lip having a base lying in a plane generally parallel to the bottom end;
wherein at least one of the following is true:
(a) the height of a first shim is different than the height of a second shim; and
(b) a degree of offset between the recess base plane and lip base plane of the first shim is different than the degree of offset between the recess base plane and lip base plane of the second shim.

17. A pipe or ducting adjustment system according to claim 16, wherein both of options (a) and (b) are true.

18. A pipe or ducting adjustment system according to claim 16, wherein the shims have substantially circular cross-sections.

19. A pipe or ducting adjustment system according to claim 16, wherein the recess or lip of a first shim includes a tongue extending outward from a sidewall of the recess or lip;
wherein the lip or recess of a second shim includes a groove extending inward from a sidewall of the lip or recess; and
wherein the tongue is configured to operatively engage the groove.

20. A pipe or ducting adjustment system according to claim 16, wherein each recess is configured to receive a cover and further wherein each lip is configured to be received in a recess of a pipe or duct.
